(19) United States
(12) Patent Application Publication
(10) Pub. No.: US 2010/0103381 A1
(43) Pub. Date: Apr. 29, 2010

(54) Image Projection System for Reducing Spectral Interference

(76) Inventor: Roger E. Yaffe, Wilsonville, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/606,991

(22) Filed: Oct. 27, 2009

Related U.S. Application Data
(60) Provisional application No. 61/108,819, filed on Oct. 27, 2008.

(51) Int. Cl. G03B 21/14

(52) U.S. Cl. 353/38; 353/81; 353/33

(57) ABSTRACT

An image projection system having a first light emitting diode subsystem configured to generate a first source beam having a first spectral range in a first polarized state and a second light emitting diode subsystem configured to generate a second source beam having a second spectral range overlapping the first spectral range is provided. The second source beam may be provided in a second polarized state orthogonal to the first polarized state of the first source beam. The image projection system may further include an x-cube prism configured to receive the first source beam and the second source beam and combine the first source beam and the second source beam to form a common output beam.

### CROSS-REFERENCE TO RELATED APPLICATIONS

This application claims priority from U.S. Provisional Patent Application No. 61/108,819 of Roger E. Yaffe, entitled “METHOD FOR BLUE-GREEN LED CROSS-TALK REDUCTION,” filed Oct. 27, 2008, the disclosure of which is hereby incorporated by reference in its entirety and for all purposes.

### BACKGROUND

Display devices utilizing image projection systems have become popular for purposes such as conducting sales demonstrations, business meetings, classroom training, and for use in home theaters. In one example, such display devices receive analog video signals from a personal computer and convert the video signals to digital video signals. The signals are electronically conditioned and processed to control an imaging device, such as liquid crystal devices and/or liquid crystal on silicon (LCOS) devices.

The image projection system included in the display device may employ a light source, such as high-intensity discharge (HID) lamps capable of providing a broad spectrum of high intensity light. However, HID lamps have several disadvantages such as high power consumption, short lifespan, and a large size when compared to other light sources such as light-emitting diodes (LEDs). For this reason, LED's have been employed as the light source for some image projection systems. Lighter, more efficient, and more portable sets of multimedia projectors have been achieved by employing light-emitting diodes (LEDs) as the light source. LED's are also less expensive and have a greater longevity than HID lamps.

However, unlike HID lamp-based systems, which have a wide separation between their red, green, and blue spectral components, LED-based systems have substantial overlap between their blue and green spectral components, giving rise to significant blue-green cross-talk. As such, band-pass filters may be employed to remove the blue-green LED cross-talk. However, use of such band-pass filters also leads to a substantial change in the system's overall color gamut, white point balance, and brightness.

### SUMMARY

An image projection system having a first light emitting diode subsystem configured to generate a first source beam having a first spectral range in a first polarized state and a second light emitting diode subsystem configured to generate a second source beam having a second spectral range overlapping the first spectral range, is provided. The second source beam may be provided in a second polarized state orthogonal to the first polarized state of the first source beam. The image projection system may further include an x-cube prism configured to receive the first source beam and the second source beam and combine the first source beam and the second source beam to form a common output beam.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates the separation between spectral components in HID lamp-based projection systems.

FIG. 2 illustrates blue-green cross-talk between spectral components in LED-based projection systems.

FIG. 3 illustrates blue-green cross-talk removal in LED-based projection systems using a band-pass filter.

FIG. 4 shows a first embodiment of an image projection system of the present disclosure.

FIG. 5 shows a second embodiment of an image projection system of the present disclosure.

FIG. 6 shows an x-cube prism that may be employed for color image combination in the image projection systems shown in FIGS. 4 and 5.

FIG. 7 shows a graph illustrating the difference in reflectance on a dichroic-coated surface between p-polarized and s-polarized light.

FIG. 8 shows a process flow depicting an example method for operating an image projection system.

### DETAILED DESCRIPTION

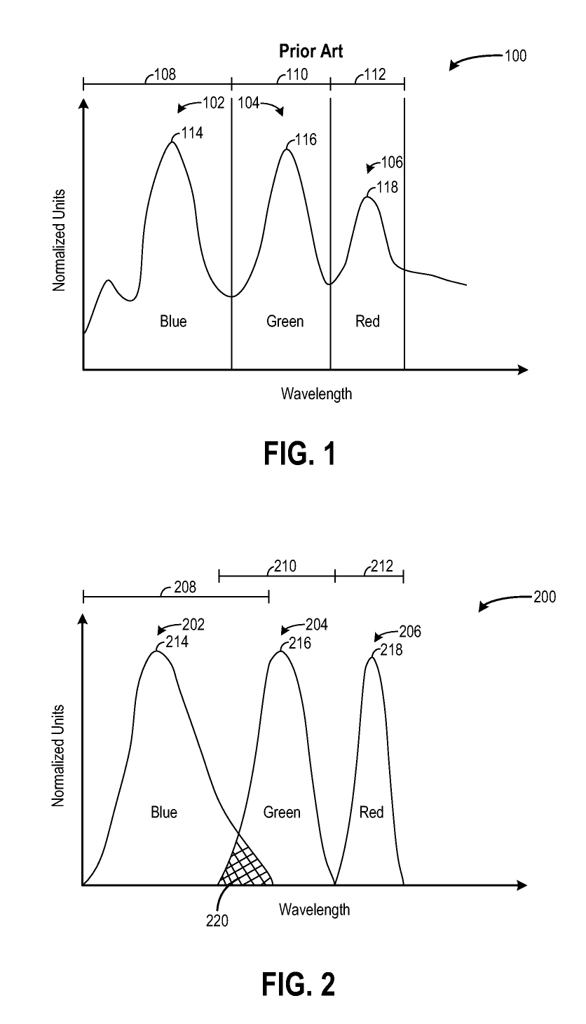

The present disclosure is directed at reducing the cross-talk between the spectral components in an image projection system. FIGS. 1-2 shows two graphs contrasting the spectral components of light produced by a high-intensity discharge (HID) lamp utilized in some prior art systems and the spectral components of light produced by a light-emitting diode (LED)-based light source.

In particular, graph 100 of FIG. 1 depicts the spectral separation of light components from a broad-spectrum light source, such as a high-intensity discharge (HID) lamp-based light source, in a prior art image projection system. The light from the HID lamp is separated into a blue spectral component 102, a green spectral component 104, and a red spectral component 106. Each spectral component has a spectral range (108, 110, and 112) and a peak wavelength (114, 116, and 118). The spectral range may indicate the range of wavelengths which may be included in each spectral component. As depicted the spectral ranges are widely separated and non-overlapping. Consequently, no cross-talk may be encountered between the spectral components.

Image projection systems may employ LED-based light source due to a variety of reasons, such as the increased longevity, decreased cost, increased color gamut, as well as the ability of the LED's to be pulsed to produce color sequential images when compared to image projection systems utilizing HID lamps. Accordingly, lighter, more compact, and efficient image projection systems may be produced when utilizing an LED-based light source.

However, unlike the widely separated spectra produce by HID lamps the spectra produced by an LED-based light source may have overlapping spectral components. Graph 200 of FIG. 2 shows the blue, green, and red spectral components, (202, 204, and 206), corresponding spectral ranges (208, 210, and 212) and peak wavelengths (214, 216, and 218) of an LED-based light source. It will be appreciated that each spectral component may be generated by a separate LED, in some examples. As shown the blue spectral component and the green spectral component overlap in a region 220, due to the characteristics of the LEDs. Thus, cross-talk between the blue and green spectral components may occur, thereby degrading the image characteristics of the system. As illustrated, the green and red spectral components 204 and 206 have significant separation and do not overlap. Therefore the red spectral range is outside the blue and green spectral ranges. However in other examples, there may be overlap between the green and red spectral components.

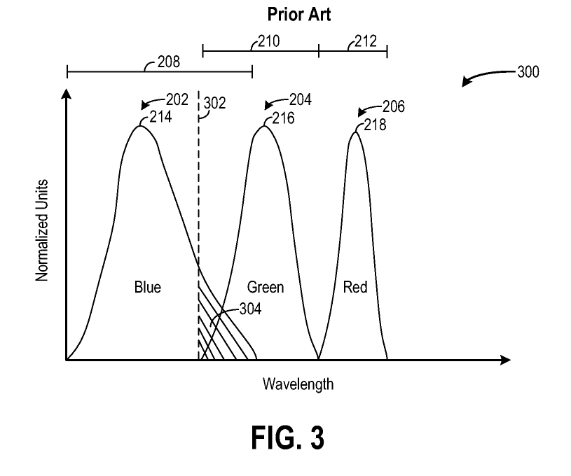

In some prior art systems using an LED-based light source a band-pass filter may be used to eliminate or reduce the blue-green cross-talk from the spectra shown in FIG. 2, as further illustrated in graph 300 of FIG. 3. Specifically, a band-pass filter having an upper cut-off wavelength 302 may be used to remove a portion 304 of blue spectral component 202, thereby preventing it from mixing with green spectral component 204. Red spectral component 206 may remain unaffected. However, by removing a substantial portion of the blue spectral component, the overall color gamut that can be attained is reduced. Furthermore, the white point balance and the brightness of the system are also negatively affected. Therefore, utilizing a band-pass filter to eliminate or reduce the blue-green cross talk may generate other problems which may adversely affect the image characteristics of the system. Another solution to reduce the cross-talk in an LED-based image projection system is needed.

Therefore, to reduce the cross-talk between the spectral components an image projection system having a first light emitting diode subsystem configured to generate a first source beam having a first spectral range in a first polarized state and a second light emitting diode subsystem configured to generate a second source beam having a second spectral range overlapping the first spectral range, the second source beam in a second polarized state orthogonal to the first polarized state, is provided. The image projection system may further include an x-cube prism configured to receive the first source beam and the second source beam and combine the first source beam and the second source beam to form a common output beam having orthogonally polarized spectral components. In this way, spectral components such as the blue and green spectral components may be orthogonally polarized, thereby eliminating the interference between the spectral components and avoiding degradation of the image characteristics of the system.

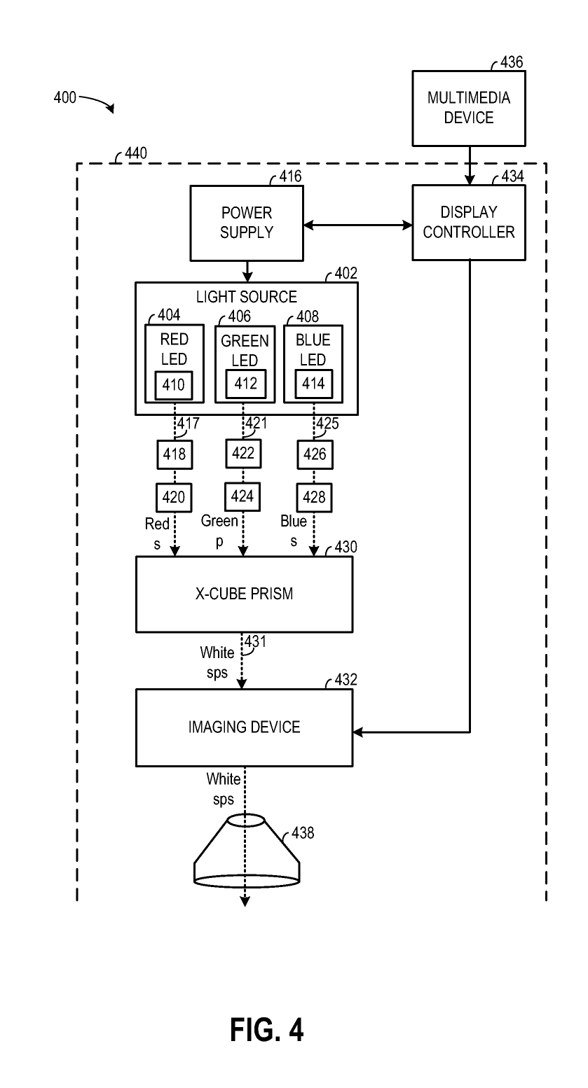

FIG. 4 shows an example embodiment of an image projection system 400 of the present invention that employs an x-cube prism 430 to substantially eliminate or reduce cross-talk between spectral components in the system. The image projection system may be included in a display device. Suitable display devices may include but are not limited to front and rear projection televisions, monitors, hand held display devices, and digital projectors adapted to display images, including text, graphics, video images, still images, presentations, etc. Such display devices may be found in home environments and applications, education environment and applications, business facilities, conference rooms and other meeting facilities, etc.

In the depicted embodiment the image projection system includes a light source 402 having a red LED subsystem 404, a green LED subsystem 406, and a blue LED subsystem 408. The red LED subsystem may include an LED configured to generate light having a peak wavelength within the red region of the visible spectrum {e.g. 620-750 nanometers (nm)}. Likewise, the green LED subsystem may include an LED configured to generate light having a peak wavelength within the red region of the visible spectrum {e.g. 495-570 nanometers (nm)} and the blue LED subsystem may include an LED configured to generate light having a peak wavelength within the red region of the visible spectrum {e.g. 450-495 nanometers (nm)}. As previously discussed with regard to FIG. 2, the spectral ranges of the light generated by the blue and green LED's may overlap. In the depicted embodiment, the red, green, and blue LED subsystems each include a polarizer (410, 412, and 414, respectively). Polarizer 410 may be configured to polarize the light in an s-state, polarizer 412 may be configured to polarize the light in a p-state, and polarizer 414 may be configured to polarize the light in an s-state. It will be appreciated that in other embodiments the polarizers may be separate from the LED subsystems. In other words, the polarizers may be positioned optically downstream of the LED subsystems. Further in other embodiment, clusters or arrays of LEDs may be arranged in the LED subsystems to form color channels. Irrespective of the configuration, light source 402 may be powered by power supply 416. In some examples, each of the LED subsystem may have a corresponding power module included in a power supply. However, in other examples the LED subsystems may be powered by a single module.

Red LED subsystem 404 may be configured to direct an s-polarized source beam 417 to a first light transmission guide 418, one or more lenses (not shown), and a first light integrator 420. Accordingly, green LED subsystem 406 may be configured to direct a p-polarized source beam 421 to a second light transmission guide 422, one or more lenses (not shown), and a second light integrator 424 and the blue LED subsystem may be configured to direct an s-polarized source beam 425 to a third light transmission guide 426, one or more lenses (not shown), and a third light integrator 428. Suitable light transmission guides may include an optical fiber waveguide, a photonic-crystal fiber waveguide, etc. Specifically in one example, the ends of optical fibers included in the light transmission guide may be mated in a one-to-one relationship with the LEDs included in the LED subsystems. The optical fibers may then be arranged in bundles. The light integrators (420, 424, and 428) may be configured to receive light from light transmission guides (418, 422, and 426 respectively) and to integrate the light by employing a variety of optical components. It will be appreciated that in some examples, the first, second, and third light transmission guides may share a common housing, in some embodiments. In other embodiments, the light integrators may not be included in the image projection system.

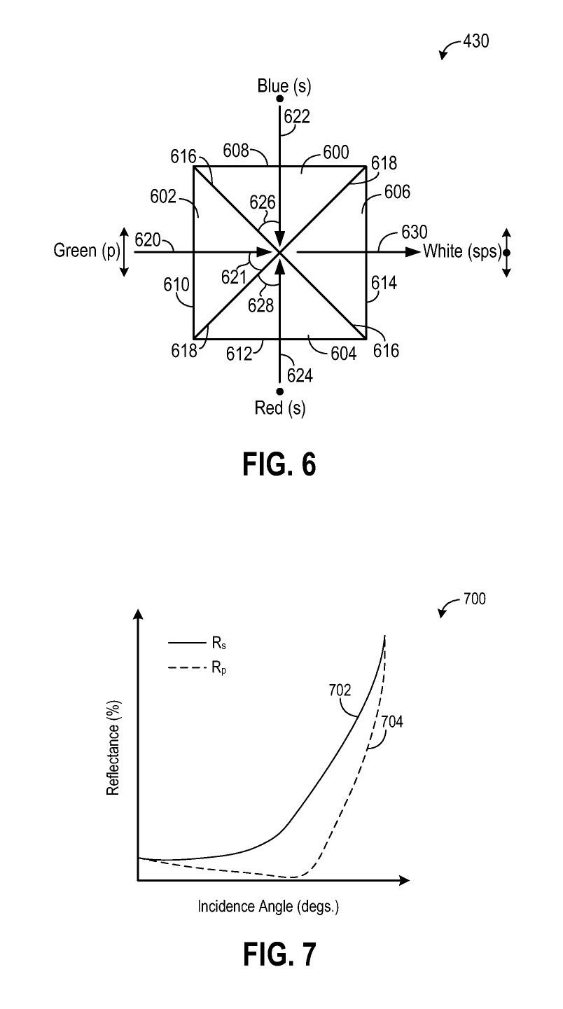

The light integrators may direct the source beams from the LED subsystems towards separate faces of an x-cube prism 430 having dichroic-coated surfaces. The structure of the x-cube prism is discussed in greater detail herein with regard to FIG. 6. X-cube prism 430 may be configured to receive and combine the source beams into a common output beam 431. As one example, s-polarized blue and red light rays may be reflected across the x-cube prism while p-polarized green light may be transmitted through the x-cube prism. In the depicted embodiment common output beam 431 is white light having a red spectral component in an s-polarized state, a green polarized component in a p-polarized state, and a blue spectral component in an s-polarized state. Therefore, the blue and green spectral components are in orthogonally polarized states. Due to the inherent differences in the nature of the orthogonally polarized light, no substantial interference may now be observed between the blue and green spectral components, thereby eliminating the cross-talk between the blue and green components. In this way, adverse affects on the image characteristics of the system caused by spectral interference may be avoided. It will be appreciated that such a system may also substantially eliminate or reduce cross-talk between other spectral components, such as the green and red spectral components.

Common output beam 431 may be relayed to imaging device 432 with the help of one or more optical path lenses (not shown) and/or light transmission guides (e.g. optical fiber transmission guides). As one example, imaging device 432 may be a liquid crystal imaging device such as a liquid crystal display (LCD) device and/or a liquid crystal on silicone (LCOS) device. LCD and LCOS are provided as examples, imaging device 432 may be any suitable device adapted to generate an image for projection.

A display controller 434, including a microprocessor, may receive color image data from a multimedia device 436, such as a personal computer or a video device, and may process the image data into frame sequential red, green, and blue image data. The sequential frame data may then be conveyed to imaging device 432 in proper synchronism with signals sent to power supply 416 to turn on and off the LED subsystems that emit the corresponding color. Display controller 434 may also be powered by power supply 416.

In one embodiment the imaging device may be an LCD imaging device including an array of pixels that are individually controlled via display controller 434. In the aforementioned embodiment the display control may be configured to interpret video signals from the multimedia device and convey pixel image patterns that control each pixel to reflect light in one of two orthogonal polarization directions depending on whether the pixel is switched to a dark or bright state condition. Pixels in the dark state condition reflect light rays without change in polarization direction, and pixels in the bright state reflect incident light rays with a 90 degree rotation in polarization direction. It will be appreciated that LCD imaging device is exemplary in nature and alternate suitable imaging device may be used, in other embodiments.

When the imaging device is of the LCD/LCOS variety, light may propagate through the imaging device and continue on to a projection lens group 438, without any substantial bend. As such, if any light is reflected away from the projection lens, it may be absorbed by a light absorbing surface (not shown). The projection lens group may be configured to direct sequentially generated images onto a display surface for viewing. The plurality of optical components may be held together by a die-case optical frame (not shown) within a projector housing 440 (only a portion of which is shown by dashed lines). The frame and housing may be adapted to include a cooling fan (not shown) for cooling the optical components. Power supply 416 may be used to power such a cooling fan. Various other optical components known to persons skilled in the art may also be included in the image projection system.

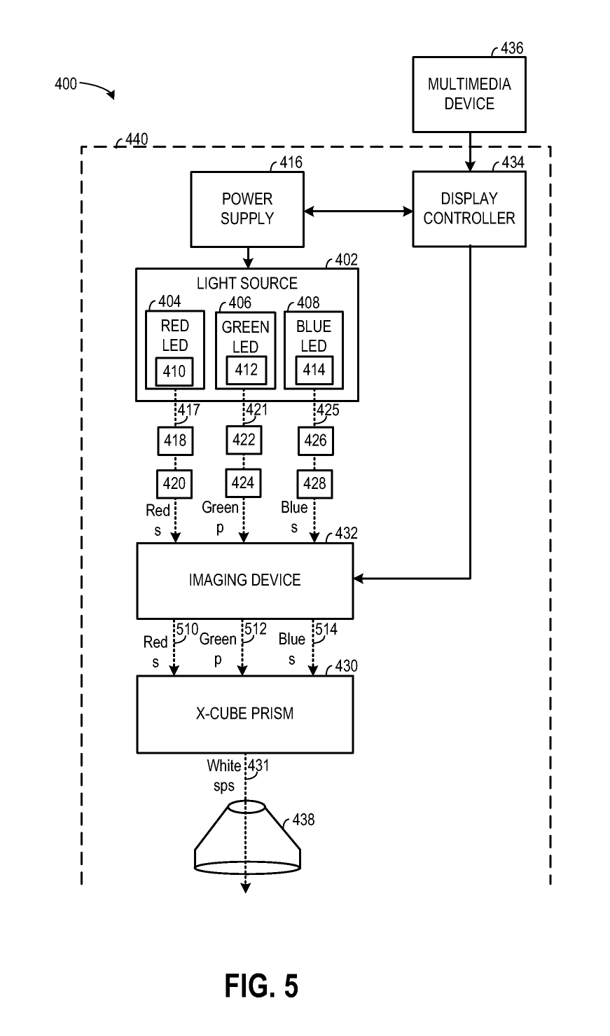

FIG. 5 shows another embodiment of image projection system 400. In the depicted embodiment the x-cube prism is positioned downstream of imaging device 432. The imaging device may be configured to separately process each source beam generated by the LED subsystems and output processed source beams 510, 512, and 514. The processed source beams may correspond to the polarization and spectral range of the input source beams 417, 421, and 425. In other words, the imaging device may process the individual spectral components (e.g. red, green, and blue) for combination downstream in the x-cube prism to form an image. Specifically in one example, the imaging device may include a blue, green, and red imager. Each imager may be configured to process the corresponding source beam to produce a series of images in a respective color. The processed source beams may then be transmitted to the x-cube prism for combination and subsequent projection. In this way, the imaging device maintains the separation of the spectral components while generating an image, preventing cross-talk of the spectral components. However, it will be appreciated that in other examples, the imaging device may combine the source beams and process a single beam to generate images.

As previously discussed imaging device 432 may be an LCOS device. Further in some examples, the LCOS device may include LCOS panels configured to selectively rotate portions of an incident beam of polarized light on a pixel-by-pixel basis. The beam of light may then be passed through a downstream polarizer which filters out the rotated light. However, in other examples the downstream polarizer may filter out the un-rotation portions of light. Further in other examples alternate suitable LCOS devices may be utilized.

FIG. 6 shows a detailed depiction of x-cube prism 430 shown in FIGS. 4 and 5. The x-cube prism 430 includes four prisms 600, 602, 604, and 606, bonded together to form a cube. In some examples, each of the prisms may include two sides forming a 90 degree angle. However, in other examples alternate angles may be formed. The third side of each prism may be an external face of the cube (608, 610, 612, and 614). Each prism includes dichroic-coated reflecting surfaces which form a first reflective surface 616 and a second reflective surface 618. As further elaborated below with reference to FIG. 7, the dichroic properties of the reflecting surfaces 616 and 618 favor reflection of s-polarized light rays over p-polarized light rays. Consequently, a major portion of p-polarized light rays may be transmitted (and not reflected) through the x-cube prism. The x-cube prism enables color image combining by directing light of different wavelengths along different faces of the x-cube prism, and then recombining all the wavelength ranges of the incident rays according to their direction of polarization.

As shown, a first source beam 620 having a first spectral range and a first polarized state, herein p-polarized light rays corresponding to a green spectral range, travels through x-cube prism 430, specifically through prism 602, and is transmitted with substantially no reflection. It will be appreciated that the first source beam 620 may correspond to source beam 421 or processed source beam 512, depicted in FIGS. 4 and 5. The first source beams has an angle of incidence 621 on the second reflective surface 618. The angle of incidence may be selected based on the characteristics of the dichroic-coated surface, discussed in greater detail herein with regard to FIG. 7.

A second source beam 622 having a second spectral range and a second polarized state, herein s-polarized light rays corresponding to a blue wavelength travels through x-cube prism 430, specifically through prism 600, and is reflected with substantially no transmission. Similarly, a third source beam 624 having a third spectral range (herein red) and a third polarized state (herein s-polarized) also travels through x-cube prism 430, specifically through prism 604, and is reflected with substantially no transmission. It will be appreciated that the second source beam 622 may correspond to source beam 425 or processed source beam 514 and the third source beam 624 may correspond to source beam 417 or 510 depicted in FIGS. 4 and 5. The second source beam has an angle of incidence 626 on the first reflective surface 616 and the third source beam has an angle of incidence 628 on the second reflective surface 618. The angles of incidence may be selected based on the characteristics of the dichroic-coated surface, discussed in greater detail herein with regard to FIG. 7.

The source beams of differing wavelengths may then be combined on the other side of the x-cube prism to generate light of a predefined color and brightness, to form a common output beam 630 of white light. The common output beam 630 may correspond to the common output beam 431 shown in FIGS. 4 and 5. In this way, the blue and green spectral components of the common output beam are orthogonally polarized. In some examples, the dichroic material used to coat the first and second reflective surfaces, 616 and 618, may be similar. However, in other example the dichroic material used to coat the first reflective surface may favor the reflectance of light in the blue region of the visible spectrum and the dichroic material used to coat the second reflective surface may favor the reflectance of light in the red region of the visible spectrum.

FIG. 7 graphically illustrates the difference in reflectance between p-polarized and s-polarized light on a dichroic-coated surface. Specifically, graph 700 depicts a variation in reflectance (along the y-axis) with varying angles of incidence (along the x-axis) for s-polarized light (curve 702, solid line) and p-polarized light (curve 704, dotted line), as determined by their polarization dependent Fresnel coefficients (Rₛ versus Rₚ). A comparison of curves 702 and 704 indicates that for light of any wavelength impinging on a dichroic-coated surface, at any given angle of incidence, a substantially higher Fresnel coefficient may be obtained for s-polarized light versus p-polarized light. As such, this translates into an efficient reflection of s-polarized light at a dichroic-coated surface but a difficult reflection of p-polarized light at the dichroic-coated surface. Consequently, a major portion of the p-polarized light is forced to be transmitted across the dichroic-coated surface. The graph is extrapolated from Fresnel's equations. Therefore it will be appreciated that Fresnel's equations may be used to select the incidence angle 621 of the first source beam 620 and to increase the transmission of p-polarized light through the dichroic coating. Additionally, Fresnel's equations may also be used to select the incidence angle 626 of the second source beam 622 and the incidence angle 628 of the third source beam 624 to increase the reflectance of s-polarized light. In this way the intensity of the common output beam may be increased.

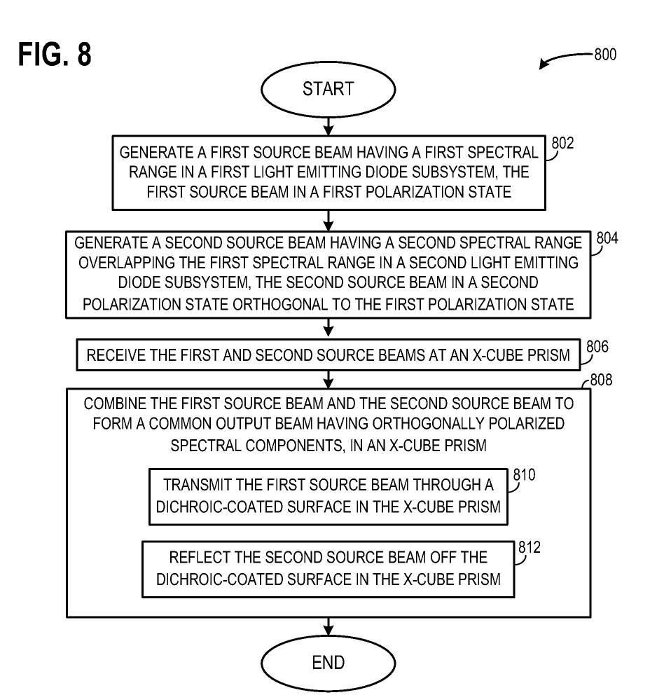

FIG. 8 shows a method 800 for operation of an image projection system. The method 800 may be implemented using the systems, devices, and components described herein, and/or via any other suitable systems, devices, and components.

At 802, method 800 includes generating a first source beam having a first spectral range in a first light emitting diode subsystem, the first source beam in a first polarized state. At 804, method 800 includes generating a second source beam having a second spectral range overlapping the first spectral range in a second light emitting diode subsystem, the second source beam in a second polarized state orthogonal to the first polarized state. At 806 the method includes receiving the first and second source beams at an x-cube prism and at 808 the method includes combining the first source beam and the second source beam to form a common output beam, in the x-cube prism.

In some examples, combining the first and second source beams includes at 810 transmitting the first source beam through a dichroic-coated surface in the x-cube prism and at 812 reflecting the second source beam off the dichroic-coated surface in the x-cube prism. In this way, the interference between the spectral components may be substantially eliminated, thereby avoiding degradation of the image characteristics of the image projection system.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. An image projection system, comprising:
a first light emitting diode subsystem configured to generate a first source beam in a first polarized state having a first spectral range;
a second light emitting diode subsystem configured to generate a second source beam having a second spectral range overlapping the first spectral range, the second source beam in a second polarized state orthogonal to the first polarized state; and
an x-cube prism configured to receive the first source beam and the second source beam and combine the first source beam and the second source beam to form a common output beam.

2. The image projection system of claim 1, wherein the second source beam is reflected off a dichroic-coated surface in the x-cube prism.

3. The image projection system of claim 2, wherein an incidence angle of the second source beam on the dichroic-coated surface is selected to increase the transmission of p-polarized light and the reflectance of s-polarized light on the dichroic-coated surface.

4. The image projection system of claim 1, wherein the first source beam is transmitted through a dichroic-coated surface in the x-cube prism.

5. The image projection system of claim 4, wherein an incidence angle of the first source beam on the dichroic-coated surface is selected to increase the transmission of p-polarized light through the dichroic-coated surface.

6. The image projection system of claim 1, further comprising a third light emitting diode subsystem configured to generate a third source beam having a third spectral range outside of the first or the second spectral ranges and wherein the x-cube prism is configured to receive the third source beam and combine the third source beam into the common output beam.

7. The image projection system of claim 1, wherein the x-cube prism includes four bonded prisms having dichroic-coated surfaces.

8. The image projection system of claim 1, further comprising an imaging device configured to receive the common output beam and generate an image for projection.

9. The image projection system of claim 8, wherein the imaging device is a liquid crystal device.

10. The image projection system of claim 1, wherein the first source beam has a peak wavelength intensity within a green region of the visible spectrum and the second source beam has a peak wavelength intensity with a blue region of the visible spectrum.

11. An image projection system, comprising:
a first light emitting diode subsystem configured to generate a first source beam in a p-polarized state having a peak wavelength with a green region of the visible spectrum and first spectral range;
a second light emitting diode subsystem configured to generate a second source beam in an s-polarized state having a second spectral range overlapping the first spectral range; and
an x-cube prism configured to receive the first and second source beams and combine the first source beam and the second source beam to form a common output beam.

12. The image projection system of claim 11, wherein the x-cube prism is a dichroic x-cube.

13. The image projection system of claim 11, wherein the x-cube prism includes four bonded prisms having dichroic-coated surfaces.

14. The image projection system of claim 11, wherein the second component is reflected off a dichroic-coated surface in the x-cube prism.

15. The image projection system of claim 14, wherein an incidence angle of the second source beam on the dichroic-coated surface is selected to increase the transmission of p-polarized light and the reflectance of s-polarized light on the dichroic-coated surface.

16. The image projection system of claim 11, further comprising an imaging device configured to receive and process the first and second source beams for combination downstream to form an image, and transmit the processed first source beam in a p-polarized state and the processed second source beam in an s-polarized state to the x-cube prism.

17. A method for operation of an image projection system, comprising:
generating a first source beam having a first spectral range in a first light emitting diode subsystem, the first source beam in a first polarized state;
generating a second source beam having a second spectral range overlapping the first spectral range in a second light emitting diode subsystem in a second light emitting diode subsystem, the second source beam in a second polarized state orthogonal to the first polarized state; and
receiving the first and second source beams at an x-cube prism; and
combining the first source beam and the second source beam to form a common output beam in the x-cube prism.

18. The method of claim 17, wherein combining includes transmitting the first source beam through a dichroic-coated surface in the x-cube prism and reflecting the second source beam off the dichroic-coated surface in the x-cube prism.

19. The method of claim 17, wherein the incidence angle of the second source beam on the dichroic-coated surface is selected to increase the transmission of p-polarized light and the reflectance of s-polarized light.

20. The method of claim 17, wherein the first source beam has a peak wavelength intensity within a green region of the visible spectrum and the second source beam has a peak wavelength intensity with a blue region of the visible spectrum.
